(19) United States
(12) Patent Application Publication
(10) Pub. No.: US 2014/0107972 A1
(43) Pub. Date: Apr. 17, 2014

(54) DISPLACEMENT MONITORING SYSTEM FOR TOWER AND MONITORING METHOD THEREOF

(71) Applicant: Zhongwei Hu, Shenzhen (CN)

(72) Inventor: Zhongwei Hu, Shenzhen (CN)

(73) Assignee: AEROSPACE SCIENCE & INDUSTRY SHENZHEN (GROUP) CO., LTD., Shenzhen (CN)

(21) Appl. No.: 14/124,164

(22) PCT Filed: Aug. 9, 2012
(86) PCT No.: PCT/CN2012/079860

§ 371 Date: Dec. 5, 2013

(30) Foreign Application Priority Data
Nov. 29, 2011 (CN) 201110385380.1

(51) Int. Cl. G01B 21/16

(52) U.S. Cl. CPC G01B 21/16
USPC 702/150; 73/488

(57) ABSTRACT

The present invention provides a displacement monitoring system for a tower, the displacement monitoring system includes a tower displacement monitoring terminal and an underground displacement monitoring terminal electrically connected to the tower displacement monitoring terminal, the tower displacement monitoring terminal is arranged on the tower and includes a main control module, an overground tower displacement sensor, a power supply module and a communication module, wherein the overground tower displacement sensor, the power supply module and the communication module are electrically connected to the main control module respectively, the underground displacement monitoring terminal is arranged on an underground bedrock and includes a controlling module and an underground displacement sensor electrically connected to the controlling module. According the technical solution, displacement sensors are used to monitor the displacement values of the tower and the bedrock respectively, then the displacement value of the tower relative to the bedrock is computed based on the displacement values of the tower and the bedrock, this technical solution overcomes the one-sidedness of only monitoring the incline angle of the tower, and is a more comprehensive monitoring solution. Thus the displacement value of the tower can be accurately monitored on line, the actual state of the tower can be monitored, and therefore it is beneficial for further plan and build of national grid.

### BACKGROUND OF THE INVENTION

1. Technical Field

The present invention relates to an online monitoring technology for monitoring states of power transmission equipment, and more particularly, to a displacement monitoring system for a tower and monitoring method thereof.

2. Description of Related Art

Due to effects of natural conditions and geological disasters, kinds of accidents of towers for high-voltage power transmission lines occur, for example, to incline towers, move towers, severely, break towers or collapse towers. Once those accidents occur, major and extraordinarily big accidents of a power grid will occur, which causes great economic loss for a country. Therefore, it is important and necessary to quickly determine whether the towers incline or move and give a warning.

At present, kinds of technologies, such as a laser, a far infrared or dual-axis incline angle transducer, are used to measure an incline angle of the tower, thus an incline state of the tower can be monitored in real time. However, the above monitoring technologies only can be used for measuring the incline angle of the tower when the tower has inclined, a horizontal or vertical displacement of the tower occurred during an earthquake or landslide can't be monitored. Thus the prior monitoring method only can be used to measure the incline angle, but it can't be used to measure the horizontal or vertical displacement, therefore the real state of the tower can't be monitored by the prior online monitoring method at the beginning of changes of geological environment in the area in which the tower is located.

### Technical Problem

A technical problem to be solved by the present invention is to overcome that the horizontal or vertical displacement can't be monitored and provide a displacement monitoring system for a tower, used to monitor the horizontal or vertical displacement of the tower.

### BRIEF SUMMARY OF THE INVENTION

The present invention provides a displacement monitoring system for a tower, wherein the displacement monitoring system includes a tower displacement monitoring terminal and an underground displacement monitoring terminal electrically connected to the tower displacement monitoring terminal;

the tower displacement monitoring terminal is arranged on the tower, comprising a main control module, an overground tower displacement sensor, a power supply module and a communication module, wherein the overground tower displacement sensor, the power supply module and the communication module are electrically connected to the main control module;

the underground displacement monitoring terminal is arranged on an underground bedrock, including a controlling module and an underground displacement sensor electrically connected to the controlling module;

the underground displacement sensor is configured to monitor a motion acceleration of the bedrock within a predetermined time t;

the controlling module is configured to compute a displacement value of the bedrock within the predetermined time t based on the motion acceleration of the bedrock and transfer the displacement value to the main control module;

the overground tower displacement sensor is configured to monitor a motion acceleration of the tower within the predetermined time t;

the main control module is configured to compute a displacement value of the tower within the predetermined time t based on the motion acceleration of the tower and compute a displacement value of the tower relative to the bedrock based on the displacement value of the bedrock;

the power supply module is configured to power the tower displacement monitoring terminal and the underground displacement monitoring terminal; and

the communication module is configured to send displacement values received and computed by the main control module to a remote monitoring terminal under control of the main control module.

Preferably, the overground tower displacement sensor and the underground tower displacement sensor are a tri-axial acceleration sensor, respectively.

Preferably, the power supply module comprises:

a wind power generation module, configured to generate electricity by wind;

a solar power generation module, configured to generate electricity by the sun;

an accumulator; and

a charging management module;

wherein the wind power generation module, the solar power generation module and the accumulator are respectively connected to the charging management module.

Preferably, the tower displacement monitoring terminal further comprises a storage module, a display module, a reset module and a clock module, wherein the storage module, the display module, the reset module and the clock module are electrically connected to the main control module;

the storage module is configured to store data computed by the main control module;

the display module is configured to locally display the date;

the reset module is configured to perform a reset operation to the tower displacement monitoring terminal; and

the clock module is configured to provide a unified work clock for the tower displacement monitoring terminal and synchronize the clock.

Preferably, the underground displacement monitoring terminal further comprises a memorizer, a reset and clock module, wherein the memorizer, the reset and clock module are electrically connected to the main control module;

the memorizer is configured to store data computed by the controlling module;

the reset and clock module is configured to perform a reset operation to the underground displacement monitoring terminal, and provide a unified work clock for the underground displacement monitoring terminal and synchronize the clock.

Preferably, the main control module is communicated with the controlling module by RS485 bus.

The present invention further provides a monitoring method of a displacement monitoring system for a tower, wherein the monitoring method includes:

Monitoring and computing a displacement value of the tower;

Monitoring and computing a displacement value of an underground reference point;

Computing a displacement value of the tower relative to the reference point based on the displacement value of the tower and the displacement value of the underground reference point;

Sending the displacement value of the tower, the displacement value of the underground reference point and the displacement value of the tower relative to the underground reference point to a remote monitoring terminal;

Wherein the underground reference point is a position of an underground displacement sensor arranged on an underground bedrock.

Preferably, the step of monitoring and computing a displacement value of the tower comprises:

Monitoring motion accelerations aₓ, a_{y} and a_{z} respectively along three axes within a predetermined time t, and computing displacement values Dₓ, D_{y} and D_{z} along the three axes within the predetermined time t, wherein aₓ, a_{y} and a_{z} are motion accelerations respectively along X axis, Y axis and Z axis, Dₓ, D_{y} and D_{Z} are displacement values respectively along X axis, Y axis and Z axis;

wherein the X axis and Y axis are two coordinate axes perpendicular to each other in a horizontal direction, the Z axis is a coordinate axis across an intersection of the X axis and the Y axis in a vertical direction.

Preferably, the step of monitoring and computing a displacement value of an underground reference point comprises:

Monitoring motion accelerations bₓ, b_{y} and b_{z} of the underground reference point respectively along the X axis, Y axis and Z axis within the predetermined time t, and computing displacement values Tₓ, T_{y} and T_{z} of the underground reference point along the X axis, Y axis and Z axis within the predetermined time t.

Preferably, the step of computing a displacement value of the tower relative to the reference point based on the displacement value of the tower and the displacement value of the underground reference point comprises:

Computing a displacement value of the tower relative to the reference point along the X axis by expression Lₓ=Dₓ−Tₓ;

Computing a displacement value of the tower relative to the reference point along the Y axis by expression L_{y}=D_{y}−T_{y}; and

Computing a displacement value of the tower relative to the reference point along the Z axis by expression L_{z}=D_{z}−T_{z}.

Preferably, the step of computing displacement values Dₓ, D_{y} and D_{z} along the X axis, Y axis and Z axis within the predetermined time t comprises:

Computing the displacement value of the tower along the X axis by expression

$${D}_{x} = {V}_{x} t + \frac{1}{2} {a}_{x} {t}^{2} ,$$

wherein when the displacement value of the tower along the X axis is computed at the first time, the value of Vₓ is zero, and in following computation of the displacement value of the tower along the X axis the value of Vₓ is a speed of the tower at the end of previous computation of the displacement value of the tower along the X axis and is computed by expression Vₓ=V′ₓ+a′ₓt, wherein V′ₓ is an initial value in the previous computation of the displacement value of the tower along the X axis, a′ₓ is a motion acceleration of the tower along the X axis obtained from the previous computation of the displacement value of the tower along the X axis;

Computing the displacement value of the tower along the Y axis by expression

$${D}_{y} = {V}_{y} t + \frac{1}{2} {a}_{y} {t}^{2} ,$$

wherein when the displacement value of the tower along the Y axis is computed at the first time, the value of V_{y} is zero, and in following computation of the displacement value of the tower along the Y axis the value of V_{y} is a speed of the tower at the end of previous computation of the displacement value of the tower along the Y axis and is computed by expression V_{y}=V′_{y}+a′_{y}t, wherein V′_{y} is an initial value in the previous computation of the displacement value of the tower along the Y axis, a′_{y} is a motion acceleration of the tower along the Y axis obtained from the previous computation of the displacement value of the tower along the Y axis; and

Computing the displacement value of the tower along the Z axis by expression

$${D}_{z} = {V}_{z} t + \frac{1}{2} {a}_{z} {t}^{2} ,$$

wherein when the displacement value of the tower along the Z axis is computed at the first time, the value of V_{z} is zero, and in following computation of the displacement value of the tower along the Z axis the value of V_{z} is a speed of the tower at the end of previous computation of the displacement value of the tower along the Z axis and is computed by expression V_{z}=V′_{z}+a′_{z}t, wherein V′_{z} is an initial value in the previous computation of the displacement value of the tower along the Z axis, a′_{z} is a motion acceleration of the tower along the Z axis obtained from the previous computation of the displacement value of the tower along the Z axis.

Preferably, the step of computing displacement values Tₓ, T_{y} and T_{z} of the underground reference point along the X axis, Y axis and Z axis within the predetermined time t comprises:

Computing the displacement value of the underground reference point along the X axis by expression

$${T}_{x} = {U}_{x} t + \frac{1}{2} {b}_{x} {t}^{2} ,$$

wherein when the displacement value of the underground reference point along the X axis is computed at the first time, the value of Uₓ is zero, and in following computation of the displacement value of the tower along the X axis the value of Uₓ is a speed of the underground reference point at the end of previous computation of the displacement value of the underground reference point along the X axis and is computed by expression Tₓ=U′ₓ+b′ₓt, wherein U′ₓ is an initial value in the previous computation of the displacement value of the underground reference point along the X axis, b′ₓ is a motion acceleration of the underground reference point along the X axis obtained from the previous computation of the displacement value of the underground reference point along the X axis;

Computing the displacement value of the underground reference point along the Y axis by expression

$${T}_{y} = {U}_{y} t + \frac{1}{2} {b}_{y} {t}^{2} ,$$

wherein when the displacement value of the underground reference point along the Y axis is computed at the first time, the value of U_{y} is zero, and in following computation of the displacement value of the tower along the Y axis the value of U_{y} is a speed of the underground reference point at the end of previous computation of the displacement value of the underground reference point along the Y axis and is computed by expression T_{y}=U′_{y}+b_{y}t, wherein U′_{y} is an initial value in the previous computation of the displacement value of the underground reference point along the Y axis, b′_{y} is a motion acceleration of the underground reference point along the Y axis obtained from the previous computation of the displacement value of the underground reference point along the Y axis; and

Computing the displacement value of the underground reference point along the Z axis by expression

$${T}_{z} = {U}_{z} t + \frac{1}{2} {b}_{z} {t}^{2} ,$$

wherein when the displacement value of the underground reference point along the Z axis is computed at the first time, a value of U_{z} is zero, and in following computation of the displacement value of the tower along the Z axis the value of U_{z} is a speed of the underground reference point at the end of previous computation of the displacement value of the underground reference point along the Z axis and is computed by expression T_{z}=U′_{z}+b′_{z}t, wherein U′_{z} is an initial value in the previous computation of the displacement value of the underground reference point along the Z axis, b′_{z} is a motion acceleration of the underground reference point along the Z axis obtained from the previous computation of the displacement value of the underground reference point along the Z axis.

Preferably, the method further comprises:

Computing an actual displacement value S of the tower relative to the reference point in the horizontal direction by expression S=\sqrt{Lₓ²+L_{y}²}based on the displacement value of the tower relative to the reference point along the X axis Lₓ=Dₓ−Tₓ and the displacement value of the tower relative to the reference point along the Y axis L_{y}=D_{y}−T_{y}, and computing a deviation angle of the tower relative to the X axis by expression

$$θ = arcsin ( \frac{{L}_{y}}{\sqrt{{L}_{x}^{2} + {L}_{y}^{2}}} ) .$$

The present invention has the following benefits: according the technical solution of the present invention, displacement sensors are used to monitor the displacement values of the tower and the bedrock respectively, then the displacement value of the tower relative to the bedrock is computed based on the displacement values of the tower and the bedrock, this technical solution overcomes the one-sidedness of only monitoring the incline angle of the tower, and is a more comprehensive monitoring solution. Thus the displacement value of the tower can be accurately monitored on line, the actual state of the tower can be monitored, and therefore it is beneficial for further plan and build of national grid.

### BRIEF DESCRIPTION OF THE SEVERAL VIEWS OF THE DRAWINGS

FIG. 1 is a structure diagram of a first embodiment of a displacement monitoring system for a tower according to the present invention;

FIG. 2 is a structure diagram of a second embodiment of a dis placement monitoring system for a tower according to the present invention;

FIG. 3 is a structure diagram of a third embodiment of a displacement monitoring system for a tower according to the present invention;

FIG. 4 is a schematic view of a position relation between a tower and an underground reference point of a displacement monitoring system for a tower according to an embodiment of the present invention; and

FIG. 5 is a schematic view of a displacement relation of a displacement monitoring system for a tower in an horizontal coordinate axis according to the present invention.

### DETAILED DESCRIPTION OF THE INVENTION

In order to make clearer the objects, technical solutions and advantages of the invention, the present invention will be explained below in detail with reference to the accompanying drawings and embodiments. It is to be understood that the following description of the embodiments is merely to explain the present invention and is no way intended to limit the invention.

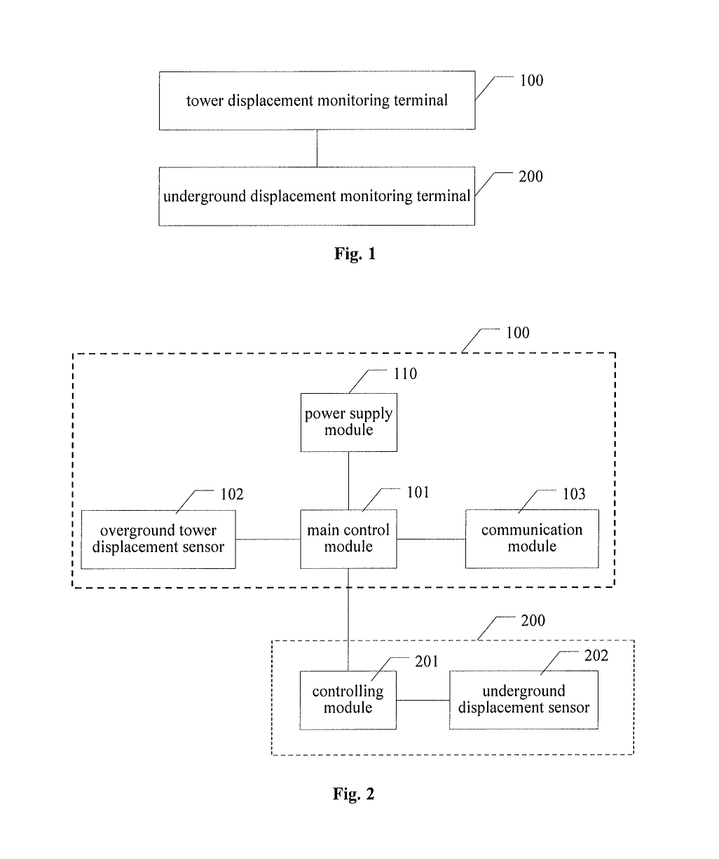

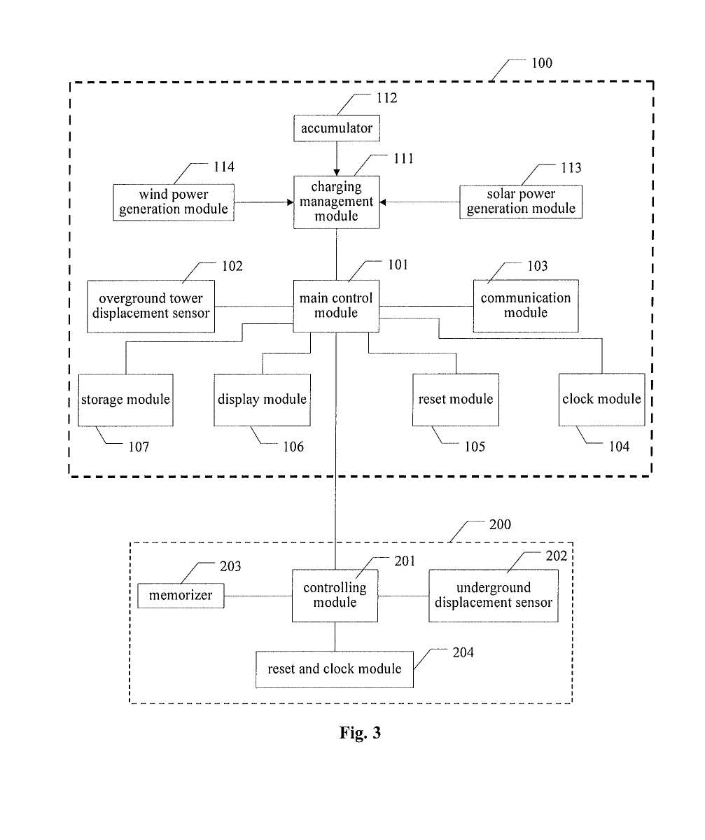

Referring to FIGS. 1, 2 and 3, a displacement monitoring system for a tower in the present invention includes a tower displacement monitoring terminal 100 and an underground displacement monitoring terminal 200, the tower displacement monitoring terminal 100 is electrically connected to the underground displacement monitoring terminal 200 and communicates with each other, the tower displacement monitoring terminal 100 is configured to monitor a displacement value of the tower, and the underground displacement monitoring terminal 200 is configured to monitor a displacement value of an underground bedrock 2.

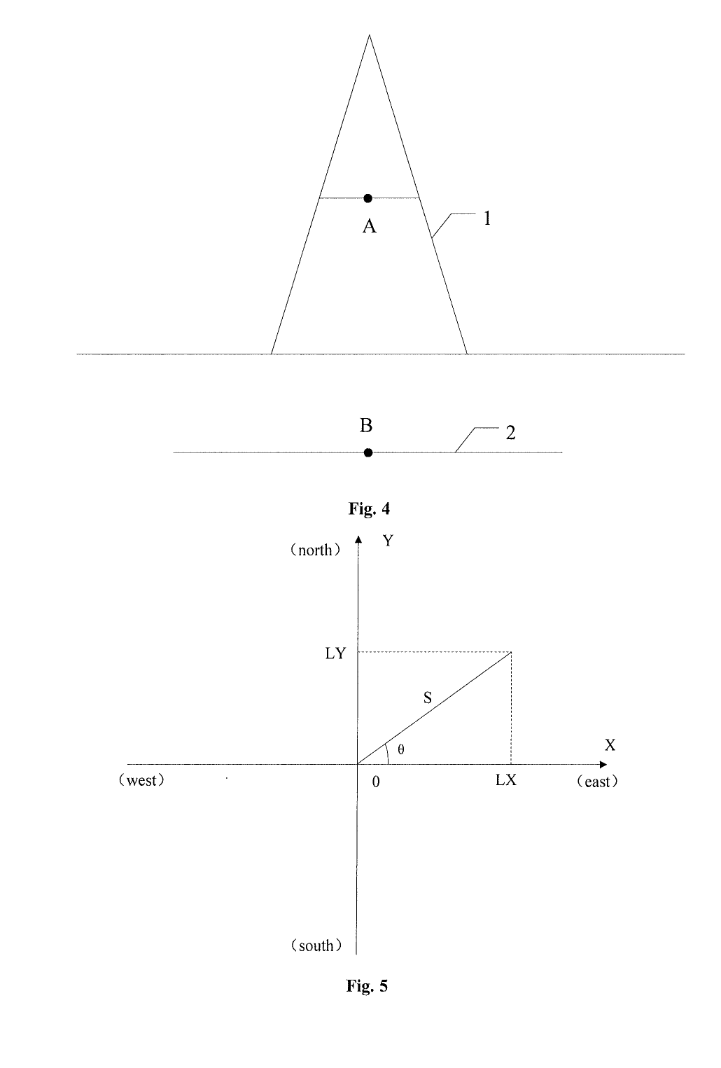

Furthermore, combining with FIG. 4, the tower displacement monitoring terminal 100 is arranged on the tower 1 and can be placed on any position of the tower, for example, the tower displacement monitoring terminal 100 can be arranged on point A of the tower 1 shown in FIG. 4. In order to reduce monitoring errors of the tower displacement caused by influences of wind on the tower, the tower displacement monitoring terminal 100 should be arranged on a middle and lower position of the tower 1 as far as possible, the tower displacement monitoring terminal 100 includes a main control module 101, an overground tower displacement sensor 102, a power supply module 110 and a communication module 103, wherein the overground tower displacement sensor 102 and the power supply module 110 and the communication module 103 are electrically connected to the main control module 101, respectively.

The underground displacement monitoring terminal 200 is arranged on an underground bedrock 2 and includes a controlling module 201 and an underground displacement sensor 202 electrically connected to the controlling module 201. In order to reduce the length of a connecting wire between the tower displacement monitoring terminal 100 and the underground displacement monitoring terminal 200 as much as possible, the underground displacement monitoring terminal 200 can be arranged on a bedrock around the tower, for example, the underground displacement monitoring terminal 200 can be placed on point B of the underground bedrock 2 shown in FIG. 4, point B can be used as an underground reference point, that is, it is the position on which the underground displacement sensor 202 is placed.

The underground displacement sensor 202 is configured to monitor a motion acceleration of the bedrock within a predetermined time t.

The controlling module 201 is configured to compute a displacement value of the bedrock within the predetermined time t based on the motion acceleration of the bedrock 2 and transfer the displacement value to the main control module 101.

The overground tower displacement sensor 102 is configured to monitor a motion acceleration of the tower 1 within the predetermined time t.

The main control module 101 is configured to compute a displacement value of the tower 1 within the predetermined time t based on the motion acceleration of the tower 1 and compute a displacement value of the tower 1 relative to the bedrock 2 based on the displacement value of the bedrock 2.

The power supply module 110 is configured to power the tower displacement monitoring terminal 100 and the underground displacement monitoring terminal 200.

The communication module 103 is configured to send displacement values received and computed by the main control module 101 to a remote monitoring terminal (not shown in figures) under the control of the main control module 101.

Preferably, the overground tower displacement sensor 102 and the underground tower displacement sensor 202 are a tri-axial acceleration sensor respectively, namely, the overground tower displacement sensor 102 can be used to monitor motion accelerations of the tower along three axes, the three axes are X coordinate axis, Y coordinate axis and Z coordinate axis, the X coordinate axis and Y coordinate axis are two coordinate axes perpendicular to each other in a horizontal direction, for example, if the X coordinate axis is an axis along east-west direction, the Y axis is an axis along north-south direction, the Z axis is a coordinate axis across an intersection of the X axis and the Y axis in a vertical direction, the Z axis are perpendicular to the X axis and the Y axis respectively. Similarly, the underground tower displacement sensor 202 can be configured to monitor motion accelerations of the bedrock 2 along the X coordinate axis, Y coordinate axis and Z coordinate axis.

The controlling module 201 can respectively compute displacement values Tₓ, T_{y} and T_{z} of the bedrock along the X axis, Y axis and Z axis based on motion accelerations bₓ, b_{y} and b_{z} along the X axis, Y axis and Z axis monitored by the underground tower displacement sensor 202 and send the computed displacement values of the bedrock 2 to the main control module 101. Preferably, the main control module 101 is communicated with the controlling module 201 by RS485 bus. Both the main control module 101 and the controlling module 201 can be a single chip microcomputer system.

The main control module 101 can respectively compute displacement values Dₓ, D_{y} and D_{z} of the tower 1 along the X axis, Y axis and Z axis based on motion accelerations aₓ, a_{y} and a_{z} respectively along the X axis, Y axis and Z axis monitored by the overground tower displacement sensor 102.

Furthermore, the main control module 101 also can respectively compute displacement values of the tower 1 along the X axis, Y axis and Z axis relative to the underground reference point based on displacement values Dₓ, D_{y} and D_{z} of the tower 1 along the X axis, Y axis and Z axis and the displacement values Tₓ, T_{y} and T_{z} of the bedrock 2 along the X axis, Y axis and Z axis, and obtain an actual displacement value of the tower relative to the underground reference point.

As shown in FIG. 3, as another embodiment of the present invention, the tower displacement monitoring terminal 100 further includes a storage module 107, a display module 106, a reset module 105 and a clock module 104, the storage module 107, the display module 106, the reset module 105 and the clock module 104 are electrically connected to the main control module 101 respectively, the storage module 107 is configured to store data computed by the main control module 101, the data includes displacement values of the tower, displacement values of the bedrock and so on, the display module 106 is configured to locally display the date, for example, to locally display displacement values of the tower 1 relative to the bedrock 2, the reset module 105 is configured to perform a reset operation to the tower displacement monitoring terminal, and the clock module 104 is configured to provide a unified work clock for the tower displacement monitoring terminal and synchronize the clock.

Furthermore, preferably, the power supply module 110 includes a wind power generation module 114 configured to generate electricity, or a solar power generation module 113 configured to generate electricity, an accumulator 112 and a charging management module 111. The power supply module 110 can be a wind driven generator for converting wind energy to electrical energy, and the solar power generation module 113 can be solar panels for converting solar energy to electrical energy.

The wind power generation module 114, the solar power generation module 113 and the accumulator 112 are respectively connected to the charging management module 111. The charging management module 111 can store the electrical energy converted by the wind power generation module 114 and the solar power generation module 113 to the accumulator 112, the solar power generation module 113 and the accumulator 112 are connected to the charging management module 111 respectively. The charging management module 111 also can supply the electrical energy converted by the wind power generation module 114 and the solar power generation module 113 to the tower displacement monitoring terminal 100 and the underground displacement monitoring terminal 200. At the same time, the charging management module 111 also can control the accumulator 112 to power the tower displacement monitoring terminal 100 and the underground displacement monitoring terminal 200.

Preferably, the underground displacement monitoring terminal 200 further includes a memorizer 203, a reset and clock module 204, the memorizer 203 and the reset and clock module 204 are electrically connected to the controlling module 201, the memorizer 203 is configured to store data computed by the controlling module, the reset and clock module 204 is configured to perform a reset operation to the underground displacement monitoring terminal, and provide a unified work clock for the underground displacement monitoring terminal and synchronize the clock.

The present invention further provides a monitoring method used for the above-mentioned displacement monitoring system for the tower, the monitoring method includes:

monitoring and computing a displacement value of the tower;

monitoring and computing a displacement value of an underground reference point;

computing a displacement value of the tower relative to the underground reference point based on the displacement value of the tower and the displacement value of the underground reference point;

sending the displacement value of the tower, the displacement value of the underground reference point and the displacement value of the tower relative to the underground reference point to a remote monitoring terminal;

wherein the underground reference point is a position of an underground displacement sensor arranged on an underground bedrock.

Preferably, the step of monitoring and computing a displacement value of the tower includes:

monitoring motion accelerations aₓ, a_{y} and a_{z} respectively along three axes within a predetermined time t, and computing displacement values Dₓ, D_{y} and D_{z} of the tower along the three axes within the predetermined time t, wherein aₓ, a_{y} and a_{z} are motion accelerations respectively along X axis, Y axis and Z axis, Dₓ, D_{y} and D_{z} are displacement values respectively along X axis, Y axis and Z axis;

wherein the X axis and Y axis are two coordinate axes perpendicular to each other in a horizontal direction, the Z axis is a coordinate axis across an intersection of the X axis and the Y axis in a vertical direction. The motion accelerations aₓ, a_{y} and a_{z} respectively along the X axis, Y axis and Z axis are measured by the overground tower displacement sensor 102.

Furthermore, the step of computing displacement values Dₓ, D_{y} and D_{Z} of the tower along the X axis, Y axis and Z axis within the predetermined time t includes: Computing the displacement value of the tower along the X axis by expression

$${D}_{x} = {V}_{x} t + \frac{1}{2} {a}_{x} {t}^{2} ,$$

wherein when the displacement value of the tower along the X axis is computed at the first time, the value of Vₓ is zero, and in following computation of the displacement value of the tower along the X axis the value of Vₓ is a speed of the tower at the end of previous computation of the displacement value of the tower along the X axis and is computed by expression Vₓ=V′ₓ+a′ₓt, wherein V′ₓ is an initial value in the previous computation of the displacement value of the tower along the X axis, a′ₓ is a motion acceleration of the tower along the X axis obtained from the previous computation of the displacement value of the tower along the X axis. For example, when the displacement value of the tower along the X axis is computed at the first time, the value of Vₓ is zero, after the displacement value of the tower along the X axis is computed at the first time, namely, after the time t the speed of the tower changes to a*t, wherein a is an acceleration measured during the computation of the displacement value of the tower along the X axis at the first time, therefore, when the displacement value of the tower along the X axis is computed at the second time, the value of Vₓ is a*t, after this computation, the speed of the tower changes to at+a′t, a′ is an acceleration measured during the computation of the displacement value of the tower along the X axis at the second time, by analogy, when the displacement value of the tower along the X axis is computed at every time, the value of Vₓ can be obtained.

Computing the displacement value of the tower along the Y axis by expression

$${D}_{y} = {V}_{y} t + \frac{1}{2} {a}_{y} {t}^{2} ,$$

wherein when the displacement value of the tower along the Y axis is computed at the first time, the value of V_{y} is zero, and in following computation of the displacement value of the tower along the Y axis the value of V_{y} is a speed of the tower at the end of previous computation of the displacement value of the tower along the Y axis and is computed by expression V_{y}=V′_{y}+a′_{y}t, wherein V′_{y} is an initial value in the previous computation of the displacement value of the tower along the Y axis, a′_{y} is a motion acceleration of the tower along the Y axis obtained from the previous computation of the displacement value of the tower along the Y axis.

Computing the displacement value of the tower along the Z axis by expression

$${D}_{z} = {V}_{z} t + \frac{1}{2} {a}_{z} {t}^{2} ,$$

wherein when the displacement value of the tower along the Z axis is computed at the first time, the value of V_{z} is zero, and in following computation of the displacement value of the tower along the Z axis the value of V_{z} is a speed of the tower at the end of previous computation of the displacement value of the tower along the Z axis and is computed by expression V_{z}=V′_{z}+a′_{z}t, wherein V′_{z} is an initial value in the previous computation of the displacement value of the tower along the Z axis, a′_{z} is a motion acceleration of the tower along the Z axis obtained from the previous computation of the displacement value of the tower along the Z axis.

Preferably, the step of monitoring and computing a displacement value of an underground reference point comprises:

Monitoring motion accelerations bₓ, b_{y} and b_{z} of the underground reference point respectively along the X axis, Y axis and Z axis within the predetermined time t, and computing displacement values Tₓ, T_{y} and T_{z} of the underground reference point along the X axis, Y axis and Z axis within the predetermined time t. The motion accelerations bₓ, b_{y} and b_{z} of the underground reference point respectively along the X axis, Y axis and Z axis can be measured by the underground displacement sensor 202.

Furthermore, according to the principle of the computation of the displacement value of the tower, the step of computing displacement values Tₓ, T_{y} and T_{z} of the underground reference point along the X axis, Y axis and Z axis within the predetermined time t comprises:

Computing the displacement value of the underground reference point along P the X axis by expression

$${T}_{x} = {U}_{x} t + \frac{1}{2} {b}_{x} {t}^{2} ,$$

wherein when the displacement value of the underground reference point along the X axis is computed at the first time, the value of Uₓ is zero, and in following computation of the displacement value of the tower along the X axis the value of Uₓ is a speed of the underground reference point at the end of previous computation of the displacement value of the underground reference point along the X axis and is computed by expression Tₓ=U′ₓ+b′ₓt, wherein U′ₓ is an initial value in the previous computation of the displacement value of the underground reference point along the X axis, b′ₓ is a motion acceleration of the underground reference point along the X axis obtained from the previous computation of the displacement value of the underground reference point along the X axis;

Computing the displacement value of the underground reference point along the Y axis by expression

$${T}_{y} = {U}_{y} t + \frac{1}{2} {b}_{y} {t}^{2} ,$$

wherein when the displacement value of the underground reference point along the Y axis is computed at the first time, the value of U_{y} is zero, and in following computation of the displacement value of the tower along the Y axis the value of U_{y} is a speed of the underground reference point at the end of previous computation of the displacement value of the underground reference point along the Y axis and is computed by expression T_{y}=U′_{y}+b′_{y}t, wherein Y′_{y} is an initial value in the previous computation of the displacement value of the underground reference point along the Y axis, b′_{y} is a motion acceleration of the underground reference point along the Y axis obtained from the previous computation of the displacement value of the underground reference point along the Y axis; and

Computing the displacement value of the underground reference point along the Z axis by expression

$${T}_{z} = {U}_{z} t + \frac{1}{2} {b}_{z} {t}^{2} ,$$

wherein when the displacement value of the underground reference point along the Z axis is computed at the first time, a value of U_{z} is zero, and in following computation of the displacement value of the tower along the Z axis the value of U_{z} is a speed of the underground reference point at the end of previous computation of the displacement value of the underground reference point along the Z axis and is computed by expression T_{z}=U′_{z}+b′_{z}t, wherein U′_{z} is an initial value in the previous computation of the displacement value of the underground reference point along the Z axis, b′_{z} is a motion acceleration of the underground reference point along the Z axis obtained from the previous computation of the displacement value of the underground reference point along the Z axis.

Finally, the step of computing a displacement value of the tower relative to the reference point based on the displacement value of the tower and the displacement value of the underground reference point comprises:

computing a displacement value of the tower relative to the reference point along the X axis by expression Lₓ=Dₓ−Tₓ;

computing a displacement value of the tower relative to the reference point along the Y axis by expression L_{y}=D_{y}−T_{y}; and

computing a displacement value of the tower relative to the reference point along the Z axis by expression L_{z}=D_{z}−T_{z}.

When an earthquake or other geological disasters occur, the ground will move, that is, a bedrock will move, therefore, it is desired to obtain the displacement value of the tower relative to the underground reference point. In the above-mentioned technical solution, according to objective attributes of geological disasters and the law of motion of objects, a monitoring period and the predetermined time t should be kept at millisecond level, the particular value ranges can be determined based on monitoring precision and the frequency of local geological disasters.

By using the above-mentioned monitoring method, displacement values of the tower relative to the reference point along the X axis, Y axis, Z axis can be intuitively obtained, the main control module will send the displacement values of the tower along the X axis, Y axis, Z axis, the displacement values of the underground reference point along the X axis, Y axis, Z axis and the displacement values of the tower relative to the reference point along the X axis, Y axis, Z axis to a remote monitoring terminal by the communication module 103, or display those information by the display module 106 included by the tower displacement monitoring terminal.

Referring to FIG. 5, it is assumed that the positive direction of the X axis is east and the positive direction of the Y axis is north, an actual displacement value S of the tower relative to the reference point in the horizontal direction based on the displacement value of the tower relative to the reference point along the X axis and the displacement value of the tower relative to the reference point along the Y axis. For example, if the displacement value of the tower relative to the reference point along the X axis is Lₓ and the displacement value of the tower relative to the reference point along the Y axis is L_{y}, the actual displacement value S of the tower relative to the reference point can be obtained by expression S=\sqrt{Lₓ²+L_{y}²}, and a deviation angle of the tower relative to the X axis can be obtained by expression

$$θ = arcsin ( \frac{{L}_{y}}{\sqrt{{L}_{x}^{2} + {L}_{y}^{2}}} ) ,$$

that is, the tower deviates by the angle θ from east to north relative to the underground reference point.

The present invention has been further detailed in the above descriptions with reference to the preferred embodiments; however, it shall not be construed that implementations of the present invention are only limited to these descriptions. Many simple deductions or replacements may further be made by those of ordinary skill in the art without departing from the conception of the present invention, and all of the deductions or replacements shall be considered to be covered within the protection scope of the present invention.

1. A displacement monitoring system for a tower, wherein the displacement monitoring system comprises a tower displacement monitoring terminal and an underground displacement monitoring terminal electrically connected to the tower displacement monitoring terminal;
the tower displacement monitoring terminal arranged on the tower, comprises a main control module, an overground tower displacement sensor, a power supply module and a communication module, wherein the overground tower displacement sensor, the power supply module and the communication module are electrically connected to the main control module;
the underground displacement monitoring terminal arranged on an underground bedrock, comprises a controlling module and an underground displacement sensor electrically connected to the controlling module;
the underground displacement sensor is configured to monitor a motion acceleration of the bedrock within a predetermined time t;
the controlling module is configured to compute a displacement value of the bedrock within the predetermined time t based on the motion acceleration of the bedrock and transfer the displacement value to the main control module;
the overground tower displacement sensor is configured to monitor a motion acceleration of the tower within the predetermined time t;
the main control module is configured to compute a displacement value of the tower within the predetermined time t based on the motion acceleration of the tower and compute a displacement value of the tower relative to the bedrock based on the displacement value of the bedrock;
the power supply module is configured to power the tower displacement monitoring terminal and the underground displacement monitoring terminal; and
the communication module is configured to send displacement values received and computed by the main control module to a remote monitoring terminal under control of the main control module.

2. The displacement monitoring system for the tower of claim 1, wherein the overground tower displacement sensor and the underground tower displacement sensor are a tri-axial acceleration sensor, respectively.

3. The displacement monitoring system for the tower of claim 1, wherein the power supply module comprises:
a wind power generation module, configured to generate electricity;
a solar power generation module, configured to generate electricity;
an accumulator; and
a charging management module;
wherein the wind power generation module, the solar power generation module and the accumulator are connected to the charging management module respectively.

4. The displacement monitoring system for the tower of claim 1, wherein the tower displacement monitoring terminal further comprises a storage module, a display module, a reset module and a clock module, wherein the storage module, the display module, the reset module and the clock module are electrically connected to the main control module;
the storage module is configured to store data computed by the main control module;
the display module is configured to locally display the date;
the reset module is configured to perform a reset operation to the tower displacement monitoring terminal; and
the clock module is configured to provide a unified work clock for the tower displacement monitoring terminal and synchronize the clock.

5. The displacement monitoring system for the tower of claim 1, wherein the underground displacement monitoring terminal further comprises a memorizer, a reset and clock module, wherein the memorizer, the reset and clock module are electrically connected to the main control module;
the memorizer is configured to store data computed by the controlling module;
the reset and clock module is configured to perform a reset operation to the underground displacement monitoring terminal, and provide a unified work clock for the underground displacement monitoring terminal and synchronize the clock.

6. The displacement monitoring system for the tower of claim 1, wherein the main control module is communicated with the controlling module by RS485 bus.

7. A monitoring method of a displacement monitoring system for a tower, wherein the monitoring method comprises:
monitoring and computing a displacement value of the tower;
monitoring and computing a displacement value of an underground reference point;
computing a displacement value of the tower relative to the reference point based on the displacement value of the tower and the displacement value of the underground reference point;
sending the displacement value of the tower, the displacement value of the underground reference point and the displacement value of the tower relative to the underground reference point to a remote monitoring terminal;
wherein the underground reference point is a position of an underground displacement sensor arranged on an underground bedrock.

8. The monitoring method of claim 7, wherein the step of monitoring and computing a displacement value of the tower comprises:
Monitoring motion accelerations aₓ, a_{y} and a_{z} respectively along three axes within a predetermined time t, and computing displacement values Dₓ, D_{y} and D_{z} along the three axes within the predetermined time t, wherein aₓ, a_{y} and a_{z} are motion accelerations respectively along X axis, Y axis and Z axis, Dₓ, D_{y} and D_{z} are respectively displacement values along X axis, Y axis and Z axis;
wherein the X axis and Y axis are two coordinate axes perpendicular to each other in a horizontal direction, the Z axis is a coordinate axis across an intersection of the X axis and the Y axis in a vertical direction.

9. The monitoring method of claim 8, wherein the step of monitoring and computing a displacement value of an underground reference point comprises:
Monitoring motion accelerations bₓ, b_{y} and b_{z} of the underground reference point respectively along the X axis, Y axis and Z axis within the predetermined time t, and computing displacement values Tₓ, T_{y} and T_{z} of the underground reference point along the X axis, Y axis and Z axis within the predetermined time t.

10. The monitoring method of claim 9, wherein the step of computing a displacement value of the tower relative to the reference point based on the displacement value of the tower and the displacement value of the underground reference point comprises:
Computing a displacement value of the tower relative to the reference point along the X axis by expression Lₓ=Dₓ−Tₓ;
Computing a displacement value of the tower relative to the reference point along the Y axis by expression L_{y}=D_{y}−T_{y}; and
Computing a displacement value of the tower relative to the reference point along the Z axis by expression Lₓ=D_{z}−T_{z}.

11. The monitoring method of claim 8, wherein the step of computing displacement values Dₓ, D_{y} and D_{z} along the X axis, Y axis and Z axis within the predetermined time t comprises:
Computing the displacement value of the tower along the X axis by expression
$${D}_{x} = {V}_{x} t + \frac{1}{2} {a}_{x} {t}^{2} ,$$
wherein when the displacement value of the tower along the X axis is computed at the first time, the value of Vₓ is zero, and in following computation of the displacement value of the tower along the X axis the value of Vₓ is a speed of the tower at the end of previous computation of the displacement value of the tower along the X axis and is computed by expression Vₓ=V′ₓ+a′ₓt, wherein V′ₓ is an initial value in the previous computation of the displacement value of the tower along the X axis, a′ₓ is a motion acceleration of the tower along the X axis obtained from the previous computation of the displacement value of the tower along the X axis;
Computing the displacement value of the tower along the Y axis by expression
$${D}_{y} = {V}_{y} t + \frac{1}{2} {a}_{y} {t}^{2} ,$$
wherein when the displacement value of the tower along the Y axis is computed at the first time, the value of V_{y} is zero, and in following computation of the displacement value of the tower along the Y axis the value of V_{y} is a speed of the tower at the end of previous computation of the displacement value of the tower along the Y axis and is computed by expression V_{y}=V′_{y}+a′_{y}t, wherein V′_{y} is an initial value in the previous computation of the displacement value of the tower along the Y axis, a′_{y} is a motion acceleration of the tower along the Y axis obtained from the previous computation of the displacement value of the tower along the Y axis; and
Computing the displacement value of the tower along the Z axis by expression
$${D}_{z} = {V}_{z} t + \frac{1}{2} {a}_{z} {t}^{2} ,$$
wherein when the displacement value of the tower along the Z axis is computed at the first time, the value of V_{z} is zero, and in following computation of the displacement value of the tower along the Z axis the value of V_{z} is a speed of the tower at the end of previous computation of the displacement value of the tower along the Z axis and is computed by expression V_{z}=V′_{z}+a′_{z}t, wherein V′_{z} is an initial value in the previous computation of the displacement value of the tower along the Z axis, a′_{z} is a motion acceleration of the tower along the Z axis obtained from the previous computation of the displacement value of the tower along the Z axis.

12. The monitoring method of claim 9, wherein the step of computing displacement values Tₓ, T_{y} and T_{z} of the underground reference point along the X axis, Y axis and Z axis within the predetermined time t comprises:
Computing the displacement value of the underground reference point along the X axis by expression
$${T}_{x} = {U}_{x} t + \frac{1}{2} {b}_{x} {t}^{2} ,$$
wherein when the displacement value of the underground reference point along the X axis is computed at the first time, the value of Uₓ is zero, and in following computation of the displacement value of the tower along the X axis the value of Uₓ is a speed of the underground reference point at the end of previous computation of the displacement value of the underground reference point along the X axis and is computed by expression Tₓ=U′ₓ+b′ₓt, wherein U′ₓ is an initial value in the previous computation of the displacement value of the underground reference point along the X axis, b′ₓ is a motion acceleration of the underground reference point along the X axis obtained from the previous computation of the displacement value of the underground reference point along the X axis;
Computing the displacement value of the underground reference point along the Y axis by expression
$${T}_{y} = {U}_{y} t + \frac{1}{2} {b}_{y} {t}^{2} ,$$
wherein when the displacement value of the underground reference point along the Y axis is computed at the first time, the value of U_{y} is zero, and in following computation of the displacement value of the tower along the Y axis the value of U_{y} is a speed of the underground reference point at the end of previous computation of the displacement value of the underground reference point along the Y axis and is computed by expression T_{y}=U′_{y}+b′_{y}, wherein U′_{y} is an initial value in the previous computation of the displacement value of the underground reference point along the Y axis, b′_{y} is a motion acceleration of the underground reference point along the Y axis obtained from the previous computation of the displacement value of the underground reference point along the Y axis; and
Computing the displacement value of the underground reference point along the Z axis by expression
$${T}_{z} = {U}_{z} t + \frac{1}{2} {b}_{z} {t}^{2} ,$$
wherein when the displacement value of the underground reference point along the Z axis is computed at the first time, a value of U_{z} is zero, and in following computation of the displacement value of the tower along the Z axis the value of U_{z} is a speed of the underground reference point at the end of previous computation of the displacement value of the underground reference point along the Z axis and is computed by expression T_{z}=U′_{z}+b′_{z}t, wherein U′_{z} is an initial value in the previous computation of the displacement value of the underground reference point along the Z axis, b′_{z} is a motion acceleration of the underground reference point along the Z axis obtained from the previous computation of the displacement value of the underground reference point along the Z axis.

13. The monitoring method of claim 10, wherein the method further comprises:
Computing an actual displacement value S of the tower relative to the reference point in the horizontal direction by expression S=\sqrt{Lₓ²+L_{y}²} based on the displacement value of the tower relative to the reference point along the X axis Lₓ=Dₓ−Tₓ and the displacement value of the tower relative to the reference point along the Y axis L_{y}=D_{y}−T_{y}, and computing a deviation angle of the tower relative to the X axis by expression
$$θ = arcsin ( \frac{{L}_{y}}{\sqrt{{L}_{x}^{2} + {L}_{y}^{2}}} ) .$$
